(19) United States
(12) Patent Application Publication
(10) Pub. No.: US 2006/0260207 A1
(43) Pub. Date: Nov. 23, 2006

(54) Door assembly for a cabinet

(76) Inventor: Grant Chang, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/115,286

(22) Filed: Apr. 27, 2005

(51) Int. Cl. E06B 1/04

(52) U.S. Cl. 49/504

(57) ABSTRACT

A door assembly for a cabinet includes an adapter member and at least one door. Each the door is pivotably connected to the adapter member by at least two hinges. When install the door assembly to a cabinet, the door is mounted to the cabinet. Thus, it is convenient for customers assembling cabinets with at least one door. No adjustments of adjusting the door and the hinge are required.

### FIELD OF THE INVENTION

The present invention relates to a door assembly for a cabinet wherein a door or doors are pre-connected to the assembly so that the customers can conveniently assemble a cabinet with a door or doors.

### BACKGROUND OF THE INVENTION

A conventional cabinet 10 is disclosed in FIG. 1 and generally includes a top board 15, a bottom board 17, two side boards 16 connected between the top board 15 and the bottom board 17. Two doors 12 are pivotably connected to each the side board 16 by at least two hinges 14.

People love to buy things at chain stores and assemble them themselves. When the customers buy parts of cabinets, they can easily assemble the top board 15, the bottom board 17 and the two side boards simply by nails or screws. It is a difficult task for the customers to install the hinges 14 properly. Generally, it needs four screws to mount a hinge, so that sixteen screws are used to mount four hinges for two doors. It is inconvenient in installation for customers.

Besides, the hinges 14 shown in the drawing are adjustable to allow the doors 12 to be opened and closed smoothly. Each hinge 14 includes a base fixed to the cabinet and an arm which is fixed to the door 12 and can be moved relative to the base so as to adjust the verticality of the door. However, most of the customers do not know the hinge is adjustable. Even though they know it, they don't know how to adjust it or they are unable to adjust it well and it takes a lot of time to check the hinge.

### SUMMARY OF THE INVENTION

It is therefore a primary object of the present invention to provide a door assembly, when a cabinet is assembled, a door or doors can be easily and rapidly installed to the cabinet.

It is a further object of the present invention to provide the door assembly, a customer is no need to adjust the door when the door is installed to the cabinet.

The present invention will become more obvious from the following description when taken in connection with the accompanying drawings which show, for purposes of illustration only, preferred embodiments in accordance with the present invention.

### BRIEF DESCRIPTION OF THE DRAWINGS

FIG. 1 is a perspective view of a conventional cabinet;

FIG. 2 is a perspective view of a first embodiment of the door assembly of the present invention;

FIG. 3 is an exploded view of FIG. 2;

FIG. 4 shows the door assembly of the present invention is connected to a cabinet;

FIG. 5 shows a top view according to FIG. 4;

FIG. 6 is a partial enlarged view according to FIG. 5;

FIG. 7 is a sectional view taken along line 7-7 of FIG. 3;

FIG. 8 is a partial enlarged view according to FIG. 7;

FIG. 9 is a perspective view to show a second embodiment of the present invention;

FIG. 10 is an exploded view of FIG. 9;

FIG. 11 is a perspective view of a third embodiment of the present invention, and

FIG. 12 is a perspective view of a fourth embodiment of the present invention.

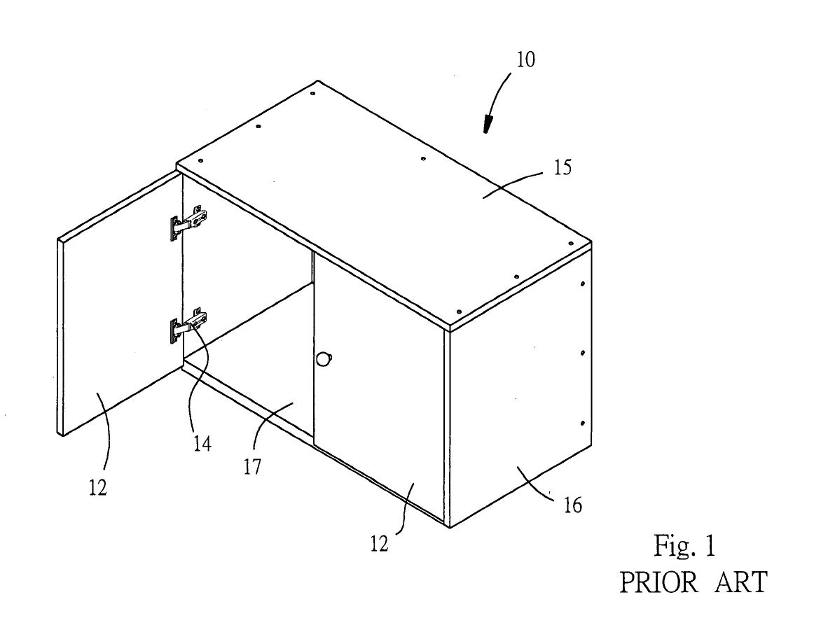

### DETAILED DESCRIPTION OF THE PREFERRED EMBODIMENT

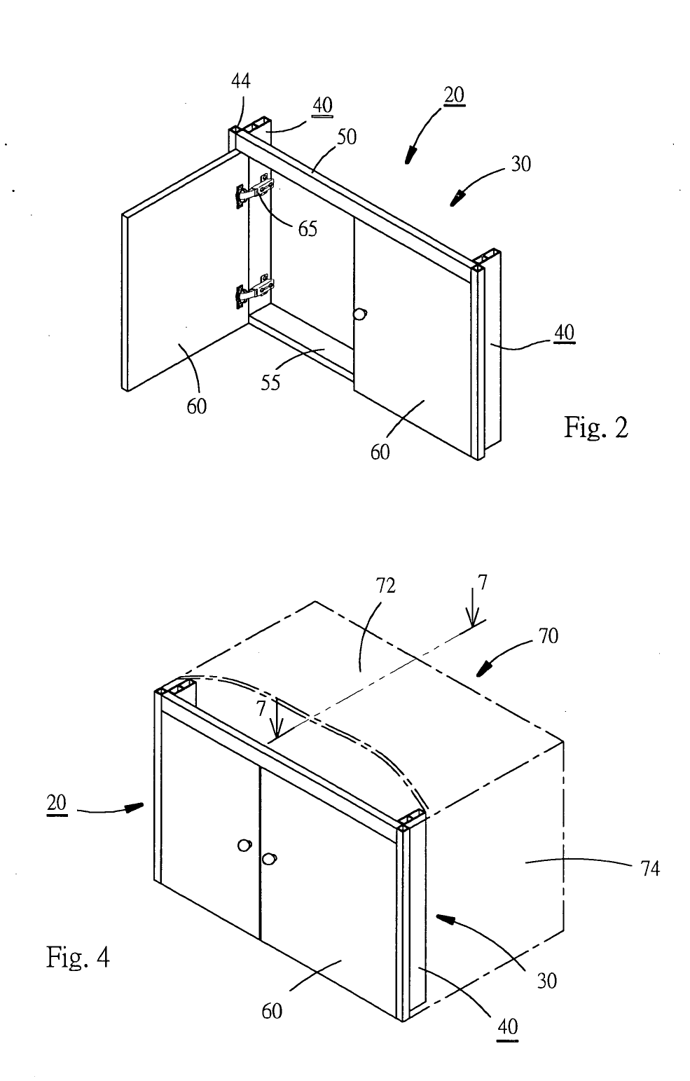

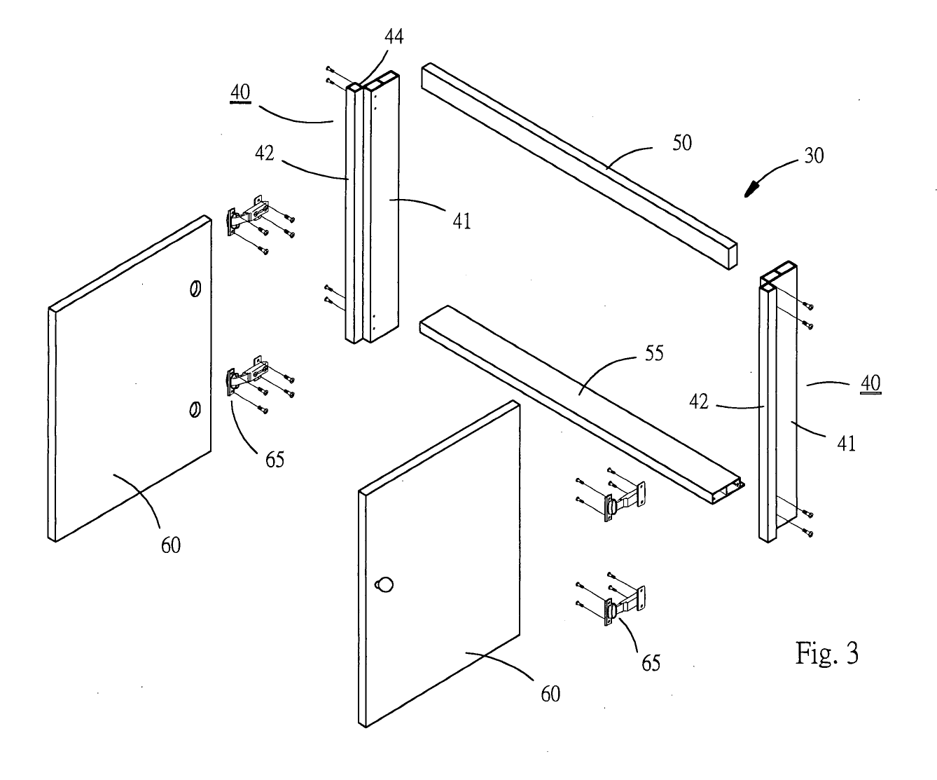

Referring to FIGS. 2 and 3, the door assembly 20 of a first embodiment of the present invention comprises an adapter member 30 and at least one door 60 pivotably connected to the adapter member 30.

The adapter member in this embodiment is a frame 30 having two posts 40 by interval and at least one beam.

Each of the post 40 is made of aluminum. Which is flat and has a single cross-section and has a short depth from front edge to rear edge thereof The post 40 has a main body 41 and a protrusion 42 on an outside of the main body 41. A position difference exists between the protrusion 42 and the main body 41. A positioning portion 44 is defined in a rear side of the protrusion 42. In addition, an edge 46 is extended backwardly from an outside of the protrusion 42 as shown in FIG. 6.

Said beam in this embodiment includes an upper beam 50 and a bottom beam 55. The upper beam 50 is connected between two top ends of the two posts 40. The bottom beam 55 is connected between two lower ends of the two posts 40. A tongue 56 is extended backwardly from a bottom of rear side of the bottom beam 55.

Two doors 60 in this embodiment are pivotably connected to the two posts 40 by two pairs of hinges 65 connected between the posts 40 and the doors 60. Accordingly the doors 60 can be opened and closed.

The door assembly 20 is shown as FIG. 2.

From a chain store when a customer buy parts of a cabinet which includes the door assembly 20 of the present invention and several boards including a top board 72, two side boards 74, a bottom board and a rear board. The customer can assemble said boards by screws into a cabinet 70 as shown in FIG. 4. The door assembly 20 is assembled by the manufacturers and the customer simply installs the door assembly 20 to the cabinet 70 after the cabinet is assembled to complete the assembling process of the cabinet 70 with doors 60.

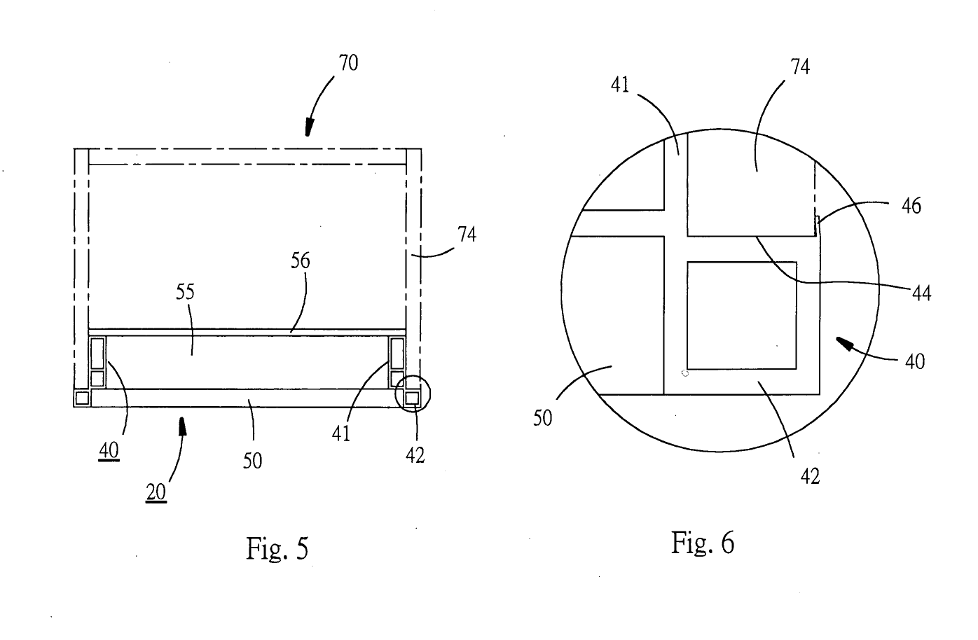

Please refer to FIGS. 5 and 6. The main body 41 of the posts 40 of the door assembly 20 is installed between the two side boards 74 of the cabinet 70. The assembly 20 is positioned when the positioning portions 44 of the posts 40 abut the front end of the side boards 74. This is convenient for the customer to position the door assembly 20 to the cabinet 70. The posts 40 and the cabinet 70 can be fixed by glue or screws.

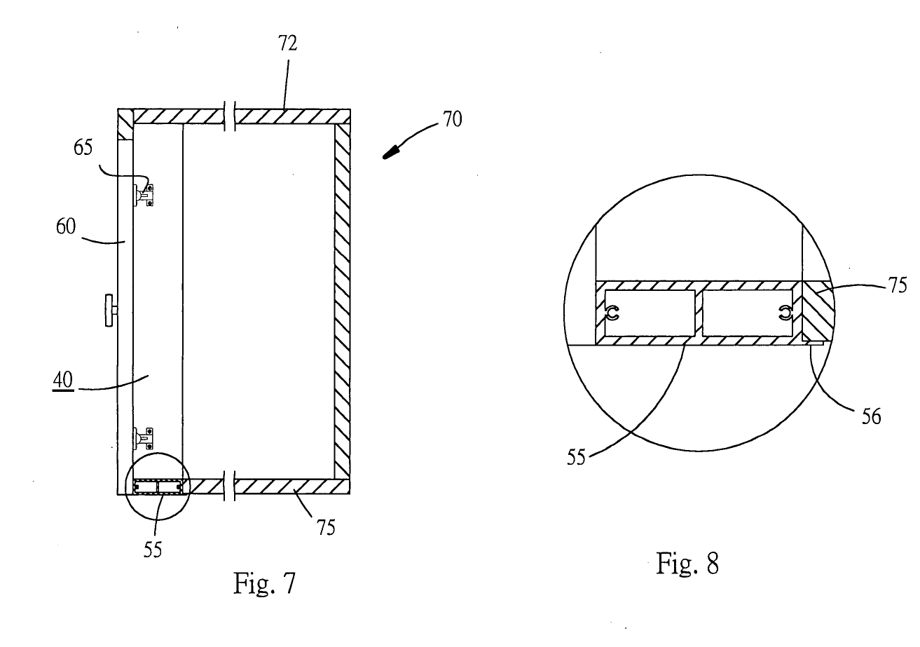

Further referring to FIG. 6, when the door assembly 20 is connected to the cabinet 70, the edges 46 of the posts 40 clamp the outer sides of the side boards 74. Besides, as shown in FIGS. 7 and 8, the bottom board 75 of the cabinet is rested on the tongue 56 of the bottom beam 55. Accordingly, the door assembly and the cabinet 70 are connected firmly.

The above arrangement is convenient for a customer assembling cabinets with doors. That is, the door assembly is pre-assembled by the manufacturer; the hinge and the verticality of the door are adjusted by the manufacturer. The customer simply installs the assembly to the cabinet and the door is mounted completely to the cabinet. No further adjustment is required for the customer.

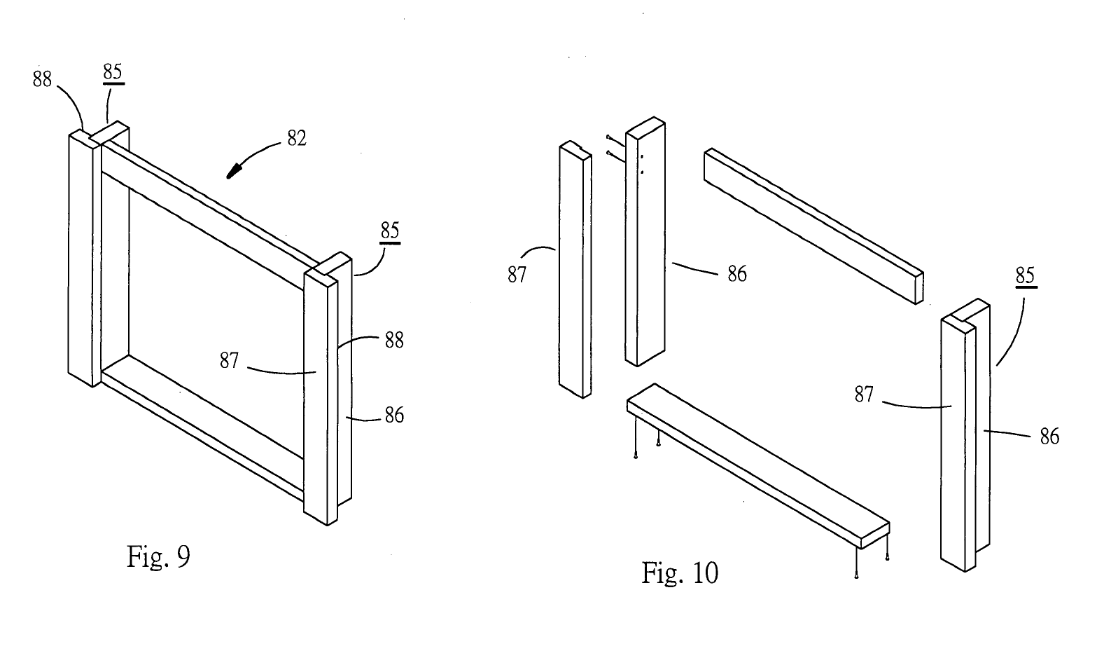

FIGS. 9 and 10 show a second embodiment of the door assembly 82 wherein the door and the hinge are not shown. Likewise, the frame 82 has two posts 85. Each of the posts 85 is made of wood and has a main body 86 and a panel 87 which is connected to a front of the main body 86 and a portion of the panel 87 extends beyond from the outside of the main body 86 so that the positioning portion 88 is defined in a rear side of portion of the panel 87 that extends outside of the main body 86 for the purpose of positioning of the frame when it is installed to a cabinet.

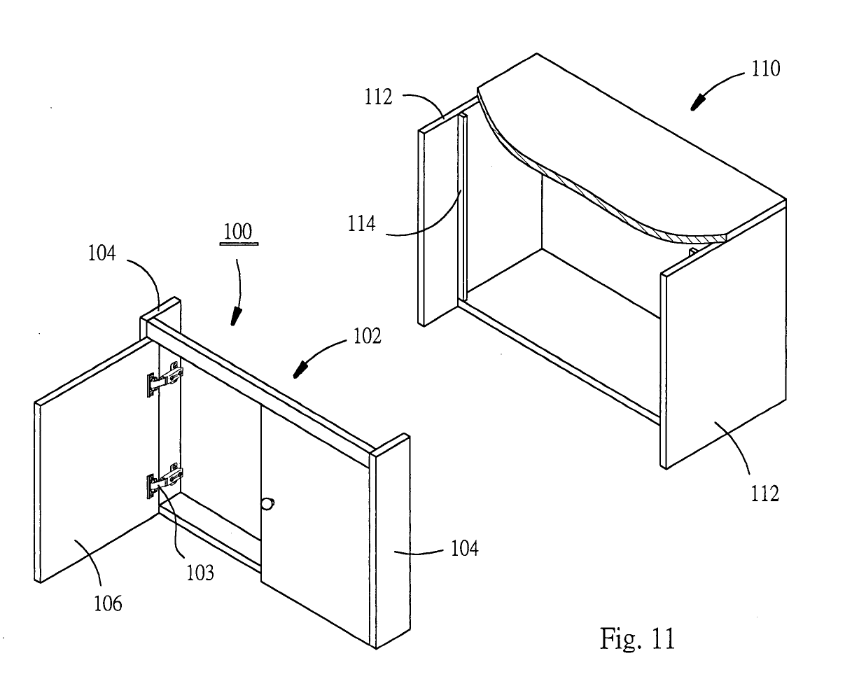

A third embodiment of the door assembly 100 is disclosed in FIG. 11. The frame 102 includes two posts 104. Two doors 106 are pivotably connected to the two posts 104 by hinges 103. There are no positioning portions on the frame. Two stops 114 are mounted on two respective insides of the side boards 112 of the cabinet 110 so that the two posts 104 contact against the two stops 114 to position the frame 102.

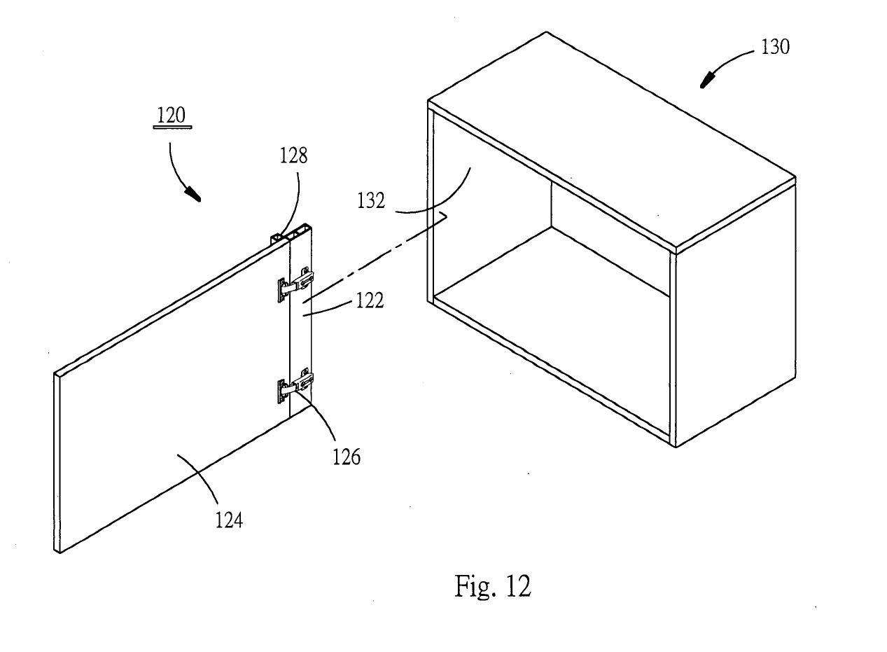

FIG. 12 shows a fourth embodiment of the door assembly 120 wherein the adapter member 122 is only one post. The post 122 can be any of the posts of the embodiments mentioned above. One door 124 is pivotably connected with the post by at least two hinges 126. A positioning portion 128 is defined in an outside of the post 122 so as to contact against the side boards 132 of the cabinet 130. Similarly, the positioning portion is not limited defined on the post.

The door assembly is pre-assembled by the manufacturers and occupies very limited space and it is easy for transporting. The customers can easily install the door assembly to the cabinet without worry of adjustment of the hinges and doors.

While we have shown and described the embodiment in accordance with the present invention, it should be clear to those skilled in the art that further embodiments may be made without departing from the scope of the present invention.

What is claimed is:

1. A door assembly for a cabinet, comprising:
an adapter member which being a frame having two posts on two sides of the frame;
at least one door;
at least two hinges, each the door is pivotably connected to one of the posts by the hinges; whereby when install the door assembly to a cabinet, the door is installed to the cabinet.

2. The assembly as claimed in claim 1, wherein each of the posts has a positioning portion on an outside thereof.

3. The assembly as claimed in claim 2, wherein each of the posts includes a protrusion protruding from an outside of the post and the positioning portion is defined in a rear side of the protrusion.

4. The assembly as claimed in claim 3, wherein the protrusion is located at a front end of each of the posts.

5. The assembly as claimed in claim 3, wherein the post and the protrusion are a one-piece member.

6. The assembly as claimed in claim 3, further comprises an edge backwardly extending from an outside of each of the protrusions.

7. The assembly as claimed in claim 2, wherein each of the posts has a main body and a panel which is connected to an outside of the main body and the positioning portion is defined in a rear side of the panel.

8. The assembly as claimed in claim 2, wherein each of the posts has a main body and a panel which is connected to a front end of the main body, the panel extends from an outside thereof and the positioning portion is defined in a rear side of a portion of the panel that extends from the outside of the main body.

9. The assembly as claimed in claim 1, wherein the assembly includes at lest one beam connected between the two posts.

10. The assembly as claimed in claim 9, wherein the beam is connected between two upper ends of the two posts.

11. The assembly as claimed in claim 9, wherein the beam is connected between two lower ends of the two posts.

12. The assembly as claimed in claim 10, further comprises a bottom beam connected between two lower ends of the two posts.

13. The assembly as claimed in claim 11, wherein the beam has a tongue extending backwardly from a bottom of rear side thereof.

14. A door assembly for a cabinet, comprising:
an adapter member which being a post;
a door;
at least two hinges; the door is pivotably connected to the post by the hinges; whereby when install the door assembly to a cabinet, the door is installed to the cabinet.

15. The assembly as claimed in claim 14, wherein a positioning portion is defined on an outside of the post.

16. The assembly as claimed in claim 15, wherein the post includes a protrusion protruding from an outside of the post and the positioning portion is defined in a rear side of the protrusion.

17. The assembly as claimed in claim 15, wherein the post has a main body and a panel which is connected to an outside of the main body and the positioning portion is defined in a rear side of the panel.

18. The assembly as claimed in claim 15, wherein the post has a main body and a panel which is connected to a front end of the main body, the panel extends from an outside thereof and the positioning portion is defined in a rear side of a portion of the panel that extends from the outside of the main body.
